(19) United States
(12) Patent Application Publication
(10) Pub. No.: US 2010/0114731 A1
(43) Pub. Date: May 6, 2010

(54) ELECTRONIC WALLET ("eWallet")

(76) Inventors: Tamara S. Kingston, Peoria, AZ (US); Joseph D. Zaruba, Wilmington, DE (US); Joseph A. Giordano, Waxhaw, NC (US); Ian E. Sundberg, Charlotte, NC (US); Jamie Ashfield, Charlotte, NC (US)

Correspondence Address: Weiss & Arons, LLP, 1540 Route 202, Suite 8, Pomona, NY, 10970, US

(21) Appl. No.: 12/362,565

(22) Filed: Jan. 30, 2009

Related U.S. Application Data
(60) Provisional application No. 61/109,849, filed on Oct. 30, 2008.

(51) Int. Cl. G06Q 20/00; G06Q 30/00; G06Q 40/00

(52) U.S. Cl. 705/26; 705/41

(57) ABSTRACT

A method according to the invention may preferably include displaying on a computer display a menu bar that includes an online shopping enhancement icon. The method may further include receiving a selection of the icon. The method may also include, in response to receiving a selection of the icon, displaying an online shopping enhancement dialogue box including a selectable option for displaying user bank account information.

### CROSS-REFERENCE TO RELATED APPLICATION

This application claims priority from U.S. Provisional Patent Application No. 61/109,849 filed on Oct. 30, 2008, entitled “AN ELECTRONIC WALLET (“eWallet”).

### FIELD OF TECHNOLOGY

This application relates to systems and methods for implementing an electronic wallet (“eWallet”). An eWallet may be defined for the purposes of this application as electronic systems and methods that enhance transfer of shipping information, billing information, and payment information.

### BACKGROUND OF THE INVENTION

Alternative payment systems—e.g., PayPal™, ACH or balance funded payments, Prepaid, Instant Credit, Bill Me Later™—constitute about 14% of online customer-to-business (“C2B”) payments to merchants in 2007. Such payment systems are projected to grow to 30% of the total market by 2012.

Non-bank institutions such as PayPal™ and Bill Me Later™ have established leadership positions by satisfying customer needs for online payment security and convenience.

Competition in the field of alternative payment systems is focused on improving both the convenience and security value proposition with single-click and plug-in products that auto-fill data and randomly generate secure account numbers to mask the payment account. Consumer data suggests overcoming security concerns and improving convenience should attract more customers and generate more transactions.

Another alternative payment system is ShopSafe™. In ShopSafe, customers may sign on to online banking to access ShopSafe, enter account spending limits and account authentication expiration. ShopSafe automatically generates a temporary account number that allows the customers to complete their purchase while protecting their privacy.

ShopSafe generates a 16-digit account number. The ShopSafe 16-digit account number works just like a regular credit card. Each ShopSafe number can be used at only one online merchant. Customers may reuse the same ShopSafe number at the same merchant.

It would be desirable, therefore, to provide apparatus and methods for providing an enhanced eWallet that further promotes transfer of shipping information, billing information and payment information for use with online purchases.

### SUMMARY OF THE INVENTION

It is an object of this invention to provide apparatus and methods for providing an enhanced eWallet that further promotes transfer of shipping information, billing information and payment information for use with online purchases.

An eWallet according to the invention preferably provides customers with an electronic wallet application that can be downloaded onto a customer's desktop. The wallet makes online shopping fast, easy and convenient. The customer online experience can be improved, according to the invention, by expediting the eWallet enrollment process, providing interaction with core financial institution accounts, reducing navigational “clicks” required to enter, and providing enhanced security by leveraging existing site key authentication.

U.S. Pat. Nos. 7,136,835 and 7,433,845 disclose technology related to the present patent application. These patents, as well as any other publications described herein, are hereby incorporated by reference herein in their respective entireties.

Presently, many online shopping sites require a customer to manually enter the customer's shipping, billing and payment information. An eWallet according to the invention preferably automatically populates a customer's online shopping profile by connecting and pulling data in real time from a financial services site affiliated with the customer. Such a site may be, for example, an online banking site.

The data stored in the online banking site may include the customer's primary address, billing addresses and debit and credit card numbers. Such information may be automatically populated into the customer's eWallet profile. Customers preferably are also able to modify their eWallet profile by selecting which addresses and payment methods they would like to add to their eWallet simply by “clicking”—i.e., selecting—a box or other suitable option or field from their respective online banking accounts.

An eWallet according to the invention preferably provides a centralized location to virtually store selected personal information. Customers can store account passwords, loyalty card numbers, frequent flier numbers and even coupon promotion codes. This information can be accessible through the eWallet when the customer is shopping online.

The eWallet may also provide customers with the ability to control and manage their spending online. Such control and management may be manifested by allowing the users to establish criteria for which selected, preferably predetermined, users are allowed to use the eWallet, define categories for eWallet use, define merchants that are acceptable, define websites that may be active for the eWallet and/or select suitable payment methods.

In certain embodiments of the invention, spending accounts with limits and expiration dates can be established, according to the invention, by the user, a retailer—e.g., for use with gift cards—or a website administrator.

In some embodiments of the invention, the ability to establish spending controls may also be implemented together with rules for payment method. For example, a debit card may be used for purchases less than a first amount, and a credit card may be used for purchases above the first amount, and a rewards card should be used at specific merchants to earn points. Any other suitable spending control algorithm and/or payment method algorithm may be implemented.

Furthermore, systems and methods according to the invention may provide the ability to use spending accounts like a virtual “gift card” by giving another person a unique card number to use anywhere online for a set amount and duration. The virtual card can be customized by adding graphics and a personalized message.

While shopping online, the eWallet may automatically appear when a customer is on a page that requires shipping, billing or payment information. Alternatively, the eWallet may appear as a toolbar option.

To access the eWallet, a customer may need to authenticate his identity using a site key. The eWallet preferably prefills shipping and billing information during checkout.

The eWallet can protect account information by generating a one-time or recurring temporary credit card number to reduce the risk of losses through exposure of account information. The eWallet can also display customer checking and credit card balances associated with a predetermined financial institution(s). Alternatively, the eWallet can display only the financial institution accounts selected to be part of the eWallet.

The eWallet may also protect account information by maintaining a static shopping number associated with a user account and providing the user with a second, dynamic, number that can be used in conjunction with the static shopping number. Such a dynamic number may be understood to function similarly to a card verification code (“CVC”) that is typically found on credit cards. The difference between the dynamic number according to the invention and the known CVC is that the dynamic number may change over time, after each use, after a plurality of uses, and/or be limited to a specific value, whereas the CVC may remain static for the typical life of the card, typically without value restriction.

In addition, customers may be provided the ability to transfer funds on the spot during the online checkout process.

In certain embodiments, offers that have been negotiated by the participating financial institution can be available to customers at checkout. If the customer accepts the offer, the eWallet may automatically prefill a promotional code field in accordance with the negotiated offer.

In addition, if a customer is searching for a particular item on the internet, the wallet may automatically present offers that are relevant to the customer's search. For example, if a customer performs an online search for an ipod™, the wallet may alert the customer that a “20% off” offer is available at BestBuy.com™. In certain embodiments of the invention, such an offer may be detected as available in the eWallet of the user. The offer resident in the eWallet may be in the form of a coupon, other promotional code associated with the product or in any suitable format. Such coupon or other promotional offer may have been stored in the eWallet by the user.

In alternative embodiments of the invention, the promotional offer may have been downloaded into the eWallet by the financial institution that supports the eWallet. The financial institution may have obtained the promotional offer through a negotiation with the product provider.

Another feature of the invention may be an ability of the eWallet to capture and store receipts. Such a feature may include a computer storage system that stores purchase, or other transaction, receipts in a digital form.

Customers may also have the ability to establish alerts. For example, the customer may be alerted if a limit is reached on a predetermined spending account. Alerts may be provided when over-limit transactions are made, on a predetermined time schedule, when account balance is low or at any other suitable interval.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a block diagram that illustrates a generic computing device that may be used according to an illustrative embodiment of the invention;

FIG. 2 is an illustrative flow diagram of a process for setting up an eWallet profile according to the invention;

FIG. 3 is an illustrative flow diagram according to the invention that continues the process shown in FIG. 2;

FIG. 4 is an illustrative flow diagram for using an eWallet at an online merchant check out according to the invention;

FIG. 5 is an illustrative flow diagram according to the invention that continues the process shown in FIG. 4;

FIG. 6 is another illustrative flow diagram of another process according to the invention;

FIG. 7 is an illustrative flow diagram according to the invention that continues the process shown in FIG. 6;

FIG. 8 shows an illustrative flow diagram that shows a continuation of the process from FIG. 7;

FIG. 9A shows an illustrative flow diagram of an authorization process that may be used in conjunction with processes according to the invention;

FIG. 9B shows an illustrative flow diagram of an authorization and settlement process according to the invention; and

FIG. 10 is an exemplary screen shot that may be used in systems and methods according to the invention.

### DETAILED DESCRIPTION OF THE INVENTION

Systems and methods according to the invention can improve customer online experience as well as bricks-and-mortar purchasing experience by leveraging existing financial institution infrastructure and account base to expedite the enrollment process, provide substantially seamless interaction with core financial institution accounts, reduce navigated “clicks” to entry, and provide improved security. Moreover, such systems and methods preferably bring banking and online shopping together by providing customers with one application that delivers the convenience of several online tools in addition to other novel features.

Many conventional online shopping tools require a customer to manually enter his or her shipping, billing and payment information. An eWallet according to the invention can automatically populate a customer's online shopping profile by accessing and retrieving data from an online banking site. The accessing and retrieval can preferably occur in real time.

The data stored in the online banking site related to customer's primary address, billing addresses and debit and credit card numbers can preferably automatically be populated into the customer's profile. Customers can then select which addresses and payment methods they would like to add to their eWallet simply by “clicking”—i.e., selecting—a box within a dialogue box.

Systems and methods according to the invention may also provide a centralized location to store personal information. Customers can store account passwords, loyalty card numbers, frequent flier numbers and even coupon promotion codes. This information will be accessible through the eWallet when the customer is shopping online.

The eWallet can further provide checking and credit card balances for the accounts selected to be part of the eWallet.

Systems and methods according to the invention may also provide customers the ability to transfer funds between financial institution accounts during the online checkout process. Alternatively, the customers may be provided with the ability to transfer funds at the point-of-purchase at a bricks and mortar location.

Another feature of the invention may relate to negotiated offers. Often a financial institution may engage in negotiating, on behalf of employees and/or customers, more advantageous rates for certain goods and services. Systems and methods according to the invention may provide such negotiated offers to customers at online checkout and/or at point of purchase in a bricks-and-mortar location. If the customer accepts the negotiated offer, the eWallet may automatically prefill the promotional code field. Alternative embodiments of the invention may allow the customer to manual enter information into the promotional code field.

In certain embodiments of the invention, if a customer is searching for a particular item on the internet, the eWallet may automatically search for existing offers relevant to the customer's search. For example, if a customer searched for an ipod™ on Google™, the wallet can alert the customer that there is a offer of a 20% price reduction available at BestBuy.com™. This feature is similar to checking one's real-life wallet for the existence of coupons. Such offers may appear in a separate window which is displayed upon the execution of the search and/or upon opening of the eWallet application.

Another feature of the invention provides the ability to implement spending accounts as a virtual “gift card”. Such virtual gift cards may include purchasing, on behalf of a third party, a unique card number to use anywhere online for a set amount and duration. The virtual card can be customized by adding graphics and personalized message.

A 2008 marketing report by Sucharita Mulpuru reports that online retail continues to grow rapidly despite choppy economic waters. Excluding the travel category, business-to-consumer eCommerce in the United States continues to grow at a rapid clip. US online sales grew 21% to $175 billion in 2007, or 7% of retail sales, and will total approximately $204 billion in 2008. Even in 2008, when retailers in general are expected to encounter challenges due to uncertain or adverse economic circumstances, online retail is projected to continue to erode market share from other channels as many consumers—particularly eCommerce enthusiasts—find the online channel to be a more convenient way to purchase merchandise.

In a recent Jupiter study, consumers sited security as their highest priority area of interest when shopping online. Hesitant shoppers indicated they would spend if they believed the transaction would be safer. Shoppers also rate increased safety above “lowest price” and rewards. An eWallet according to the invention preferably provides customers with a safer and more convenient way to shop online.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

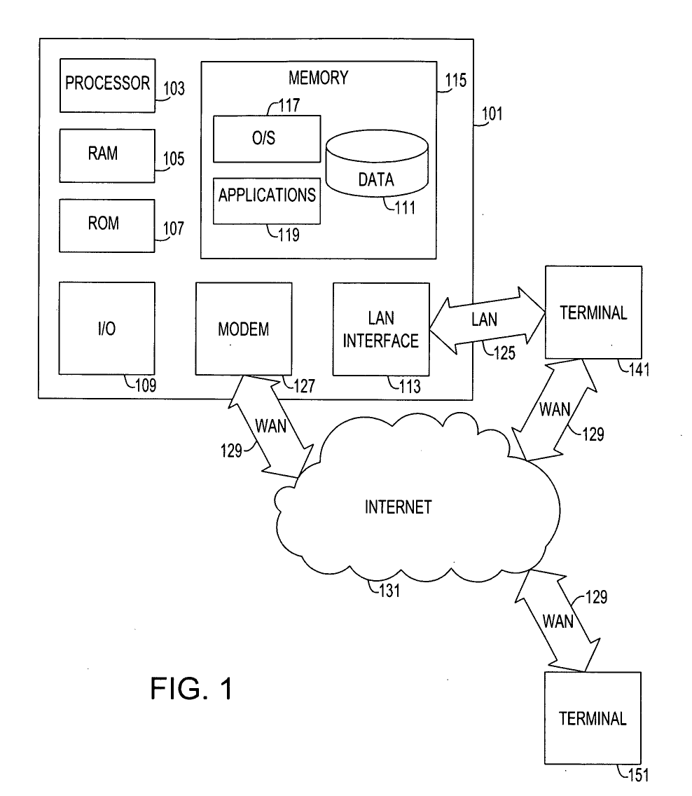

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 125.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 125 and/or storage to provide instructions to processor 103 for enabling server 101 to perform various functions. For example, memory 125 may store software used by server 101, such as an operating system 117, application programs 119, and an associated database 121. Alternatively, some or all of server 101 computer executable instructions may be embodied in hardware or firmware (not shown). As described in detail below, database 121 may provide storage for customer transaction information, customer authentication information and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

Terminal 151 and/or terminal 141 may be portable devices such as a laptop, cell phone, Blackberry™, or any other suitable device for storing, transmitting and/or transporting relevant information.

Customer information, including bank account information, customer selected information, customer transaction records, card information, card branding information, vendor information and other suitable information may be stored in memory 125.

One or more of applications 119 may include one or more algorithms that may be used for eWallet enrollment, and/or eWallet implementation. Such algorithms may include spending limit algorithms, payment method algorithms and/or any other suitable algorithms.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

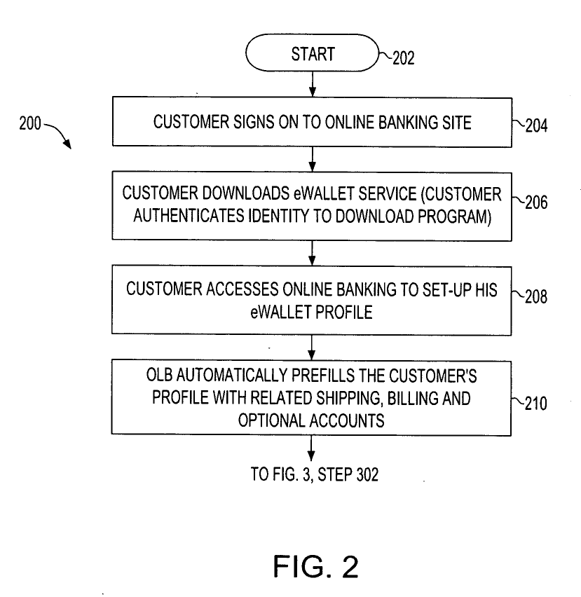

FIG. 2 shows an illustrative flow diagram of a process 200 for setting up an eWallet profile according to the invention. To participate in the eWallet service, customers preferably enroll in online banking (“OLB”) and have a related credit card and/or debit card.

Process 200 may start at 202. The customer accesses the online banking website 204 to download the wallet 206. The customer may be prompted to authenticate his identity prior to downloading the wallet.

Once the wallet is downloaded, customers can access online banking to establish his eWallet profile, 208. The OLB preferably automatically prefills the customer's profile. Online Banking can pull in the relevant shipping, billing and payment information from the system of record(s). The process according to the invention can display the eligible payment accounts and billing address.

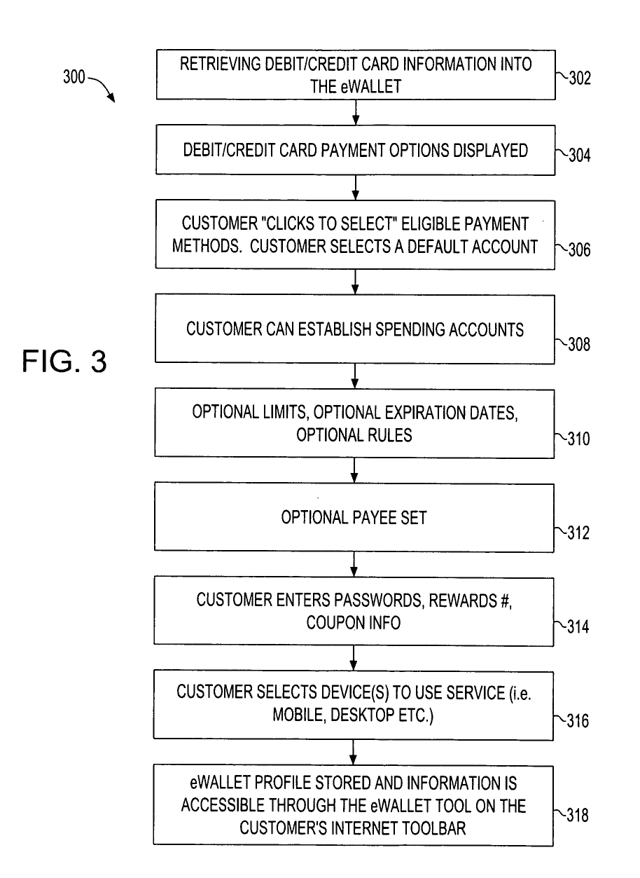

FIG. 3 shows a continuation 300 of the process 200 shown in FIG. 2. Step 302 shows retrieving debit/credit card information into the eWallet. Then, the debit/credit card payment options are displayed, 304. Step 306 shows that customers can “click” the boxes beside the accounts they want to be part of the eWallet and can select a default account for present and future purchases.

The customer can also establish spending accounts, 308. Such spending accounts may also include optional and/or selectable limits, optional and/or selectable expiration dates and optional and/or selectable rules, 310. In certain embodiments of the invention, these accounts may be set according to the payee preferences, 312.

In some embodiments of the invention (not shown), an additional user function may be provided that allows a user to set up a virtual gift card or allowance account.

Further embodiments of the invention allow a user to enter and store security information in computer memory. Such security information may include passwords, frequent flier numbers and loyalty card numbers, 314. Such a storage feature may also allow customers to retrieve and enter coupon codes and/or promotion codes.

A customer may select the device to use the eWallet service, 316. Such a selected device may include a laptop, cell phone, Blackberry™, or any other suitable device for storing, transmitting and/or transporting relevant information.

Step 318 shows that the enrollment process may be completed by storing the eWallet Profile and providing access to the information through the eWallet tool on the customer's internet toolbar.

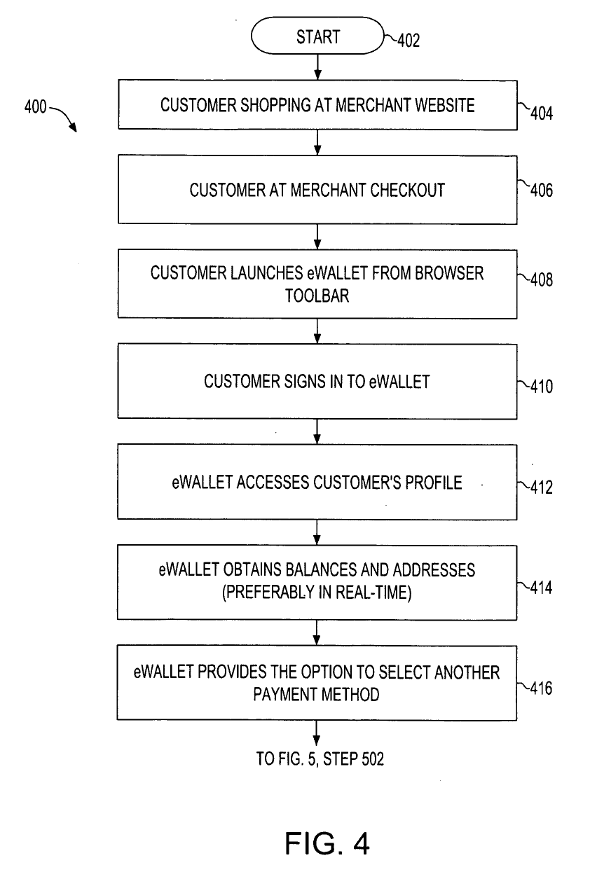

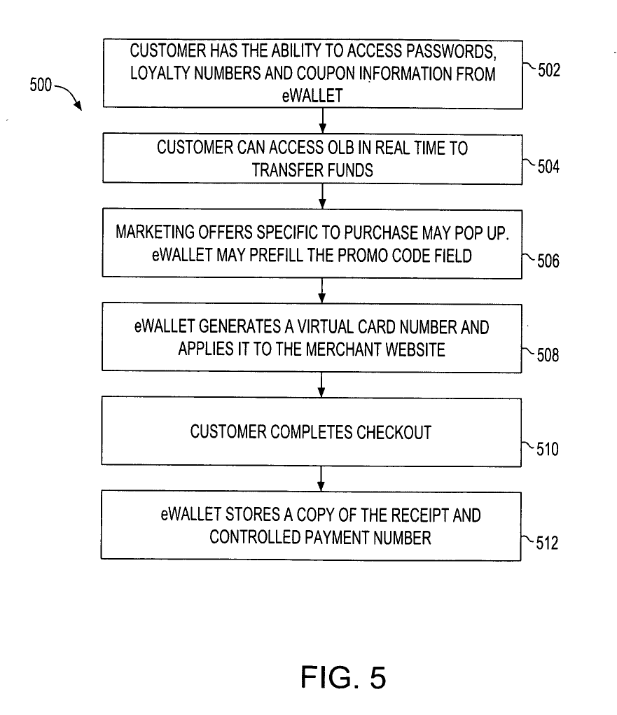

FIG. 4 and 5 show flow diagrams that illustrate a process flow 400-500 for using an eWallet at an online merchant check out. The process starts at 402. Step 404 shows the customer entering the merchant website. At merchant checkout, 406, the customer may click on the eWallet icon and launch the eWallet, 408.

The customer should preferably authenticate his identity—e.g., enter an eWallet access code, or otherwise identify himself in a suitable manner—in order to access eWallet information and features, 410. Step 412 shows that, preferably in response to customer authentication, the eWallet accesses the customer's profile. At this point, the eWallet preferably displays, in real time, the customer's account balances and the customer's payment options, 414. The eWallet may also provide the option to select another payment method, 416.

FIG. 5 shows an illustrative flow diagram that shows a continuation of the process from FIG. 4. Step 502 shows using the eWallet to access passwords, loyalty numbers and coupon information from eWallet. When the customer accesses his eWallet, he can select a link to online banking, 504, and transfer funds in real time to cover purchases.

Another feature of the invention relates to offers negotiated by the financial institution such as a bank. When a customer is searching for a particular item on the internet, the wallet can automatically present offers to them relevant to their search. The bank's negotiated offers relevant to the customers purchase can be presented, 506. For example, if the customer selects the offer, the eWallet will automatically populate the promo code field, 506.

Yet another feature of the invention can relate to generation of a unique payment number and apply the payment number to a particular merchant website, 508. The customer can complete the checkout at step 510.

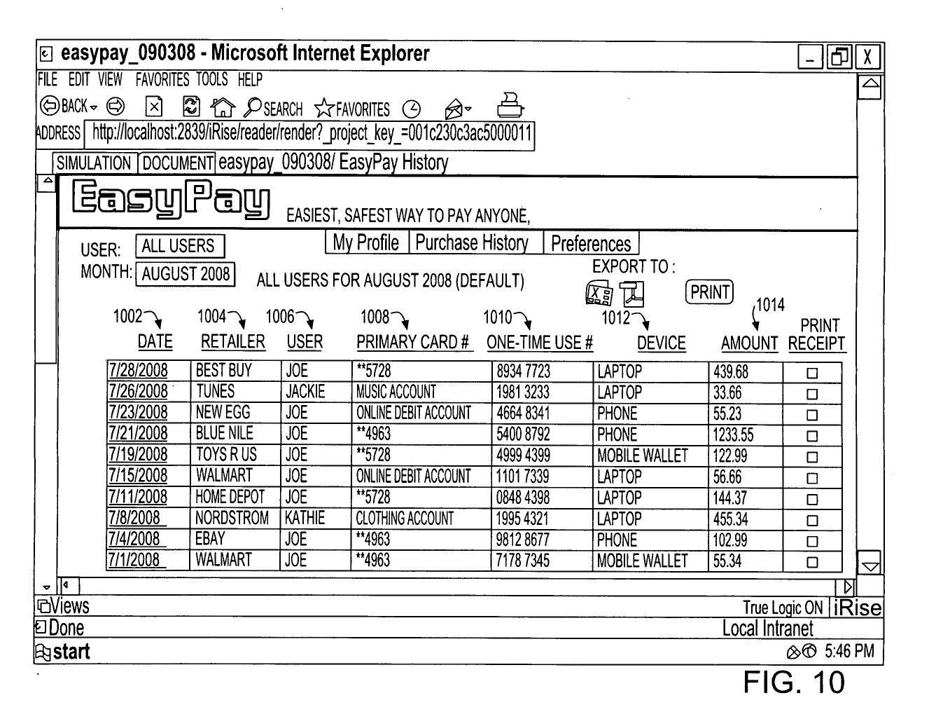

Step 512 shows the eWallet capturing a copy of the customer's receipt. Such capturing may be implemented, for example, by doing a ‘screen scrape’ or other suitable recordation of the receipt. The receipt storage feature preferably captures high level information from the receipt—e.g., purchase amount, retailer, date, one-time use number and applicable primary card number—and can store the receipt information, together with other receipt information, in an orderly fashion. Another feature of the invention (see FIG. 10) may include displaying a grid with a group of collected and aggregated receipt information.

Using processes according to the invention, the online shopping customer experience can be improved by leveraging existing online banking infrastructure and account base to expedite the enrollment process, to provide seamless interaction with core bank accounts, to minimize entry clicks, and to provide high-level security.

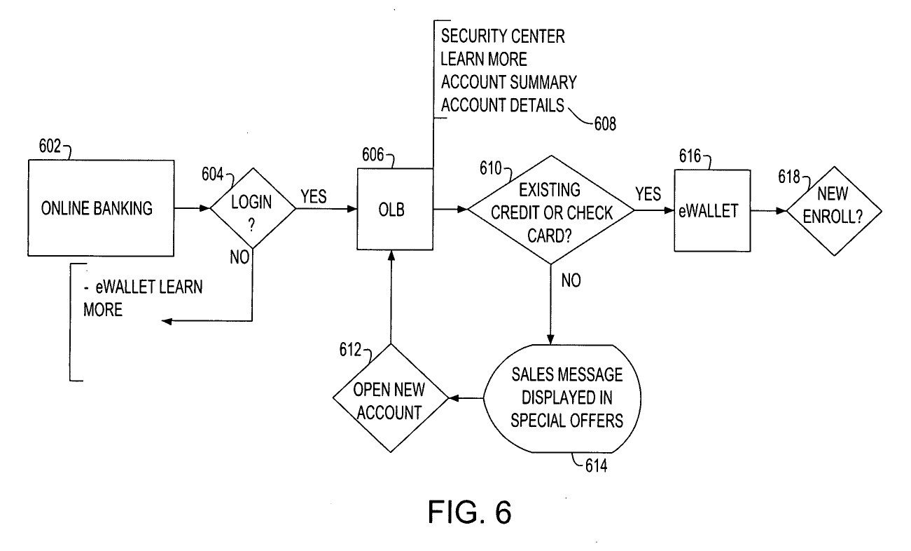

FIG. 6 shows an illustrative flow diagram of a process according to the invention. Step 602 shows entering an online banking site. Preferably, such a site provides information regarding the eWallet. At step 604, the customer can log in to the online banking site.

Once logged in to OLB 606, the site may provide further information regarding an online security center, additional education, an account summary, and/or account details, 608.

Step 610 shows querying whether the customer has a credit card or check card. If the customer does not have a credit or check card, then the process may display a sales message in a special offers tab, 612, and provide a customer the ability to open a new account, 614. Thereafter, the process may bring the customer back to OLB, 606.

If the customer already possesses a credit and/or check card, the process may continue to the eWallet application, 616, and query whether the customer is a new enrollee in the eWallet application.

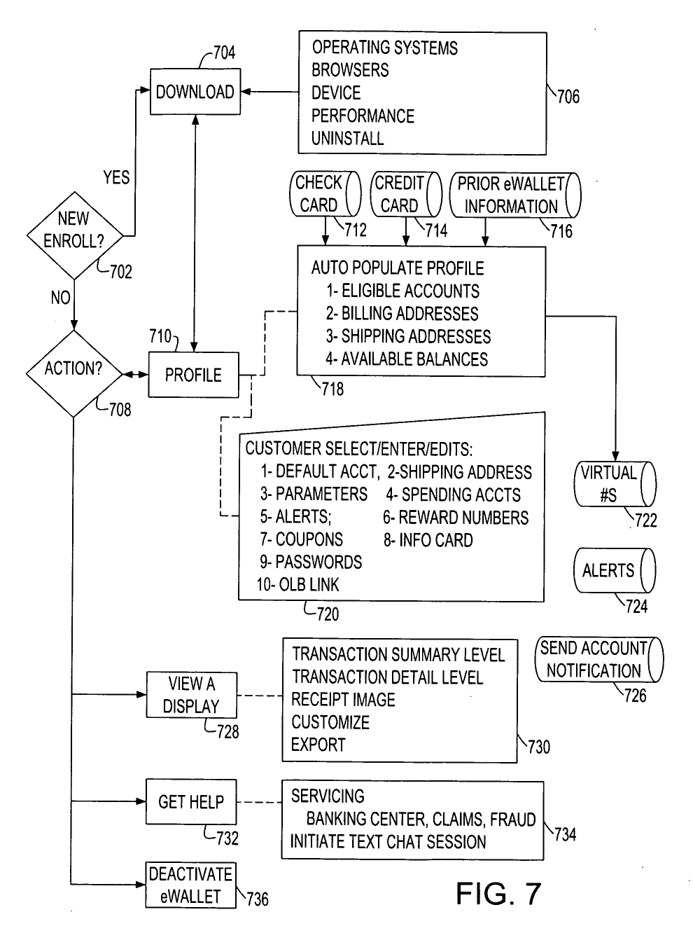

FIG. 7 shows an illustrative flow diagram that shows a continuation of the process from FIG. 6. Step 702 continues with the new/enroll box from the step 618 shown in FIG. 6. If the customer is a new enrollee, then step 704 shows downloading the eWallet application to a computing device of the customer's selection. Such a download may include information relating to operating systems, browsers, devices, device performance and uninstallation information, 706.

If the customer is not a new enrollee, then the process may query whether the customer desires to implement an eWallet action, 708. The customer profile may be accessed at step 710.

The profile may be automatically populated by a computerized transfer of information at step 718. Such automatic population may include transferring information from the customer's online banking to his eWallet. Such information may include eligible accounts information, billing addresses, shipping addresses, and/or available balances. Such information may also include credit card information 712, check card information 714, and/or prior eWallet information 716, as well as any other virtual numbers and/or codes that may have been stored, 722.

Other information 720 that may be electronically transferred into the profile may include previously recorded customer selected and entered edits, default account information, shipping addresses, parameters, spending accounts, alerts, reward numbers, coupons, information cards, passwords, and/or an OLB link.

The user may preferably select an action such as viewing a display 728 (including but not limited to a display at a transaction summary level, a display at a transaction detail level, a display of a receipt image, the display of an aggregation of receipt images, and/or a display of a screen for customizing the eWallet account, 730), viewing a get help option 732 (including but not limited to help for servicing the banking center the claims center, and/or the fraud center, and help for initiating a text chat session, 734) and/or viewing a display for deactivating the eWallet, 736.

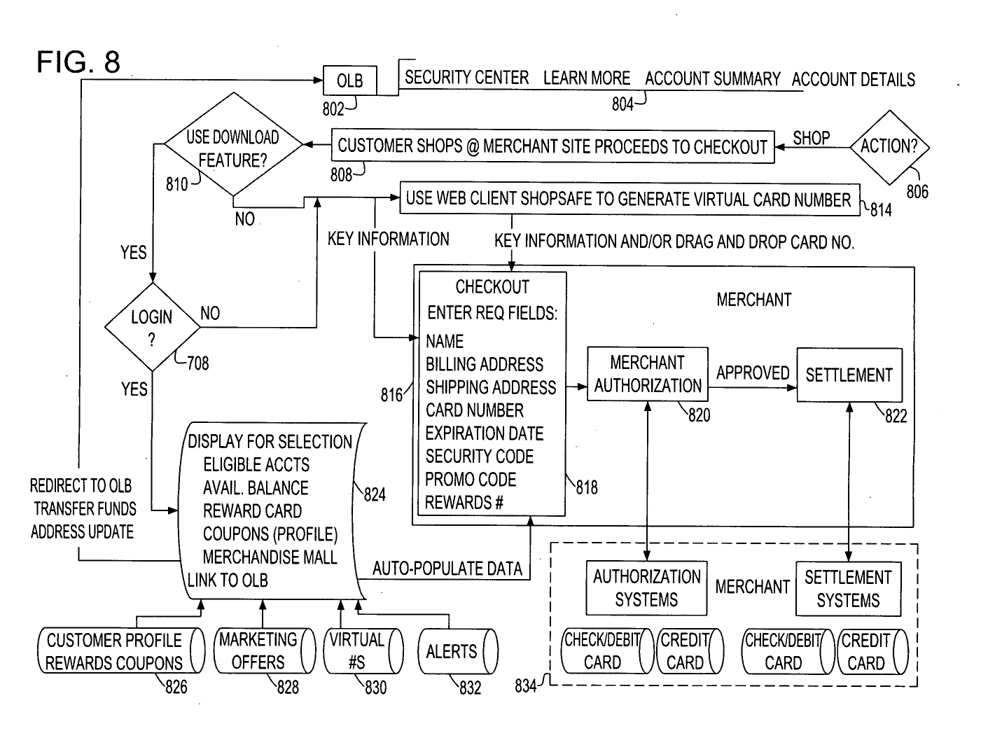

FIG. 8 shows an illustrative flow diagram that shows a continuation of the process from action element 708 shown in FIG. 7. Step 806 corresponds to step 708 in FIG. 7.

Preferably, action 806 in FIG. 8 is generated by the customer shopping at a merchant site and proceeding to checkout, 808. Step 810 queries whether the customer desires to electronically implement the download feature. If such a path is desired, then the user logs in at 812. Thereafter, an electronic display 824 is generated for the user including eligible accounts, available balance, reward card numbers, coupons, an electronic merchandise mall, and/or a Link to OLB. Inputs to step 824 may be obtained from the customer profile 826, offers 828, virtual numbers 830, and/or alerts 832.

Data used in step 824 may be stored in a computer memory at process step 824 may auto-populated to checkout fields, 816.

In one embodiment of the invention, following a declination of a download or a declination of a login request, step 814 shows generation of a virtual card number. Such a declination may be the result of a software or hardware malfunction that disallows user connection from his or her online banking site to his or her eWallet. Accordingly, this embodiment of the invention allows the user to continue to shop even though access to the eWallet may be partially or completely blocked.

Such a virtual card number may be automatically transmitted directly to a merchant at a checkout 816. Alternatively, such a virtual card number may be available to be dragged and dropped into a suitable portion of a display at a merchant's web site. In yet another alternative embodiment of the invention, the user may be provided a static shopping number and, upon occurrence of a declination as described above, the user may be provided a dynamic number that is used preferably in conjunction with the static shopping number to allow the user to shop even though access to the eWallet is partially or completely blocked.

The portion of a display at a merchant's web site may include various required fields. The merchant may also provide authorization 820, as well as approval and settlement of the purchase, 822. Such authorization may employ various settlement processes and systems 834.

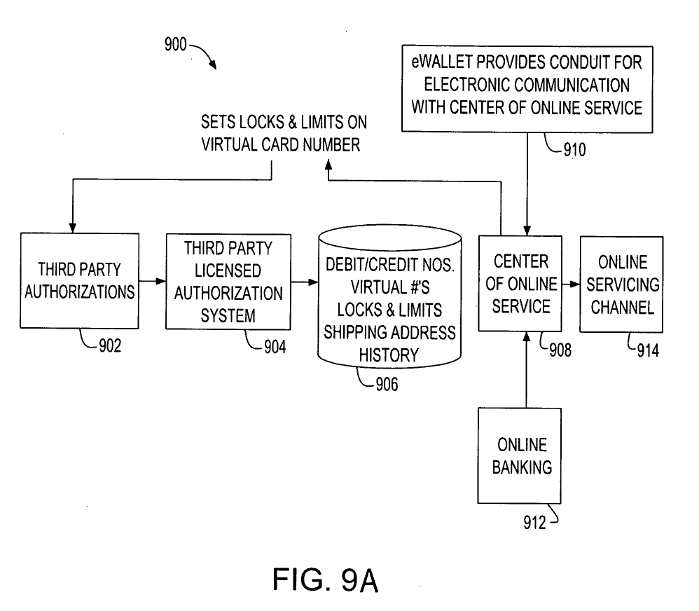

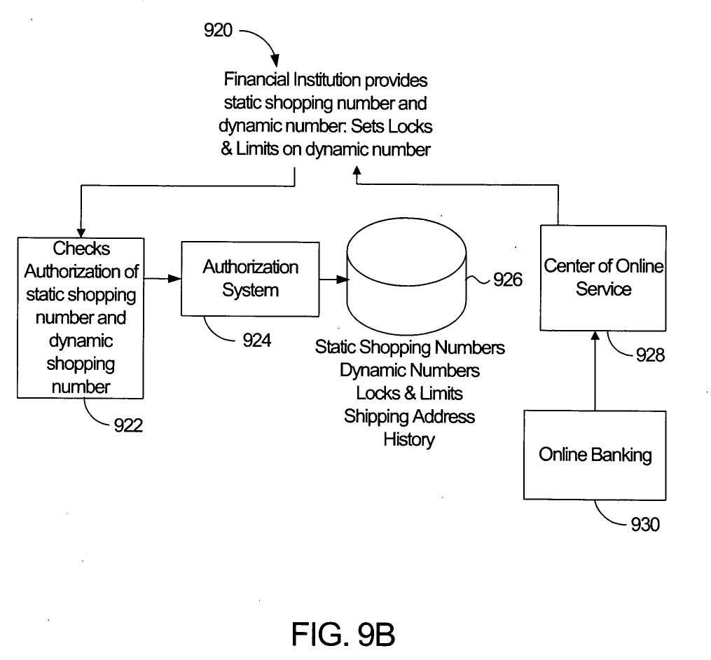

FIG. 9A shows an exemplary flow diagram of an authorization and settlement process 900 that may be used in conjunction—i.e., in the box 834 (merchant authorization and settlement systems) provided in FIG. 8—with various computerized eWallet systems according to the invention. FIG. 9 includes third party authorizations 902 which may include such known authorizations as the authorizations provided by a suitable third party provider. The third party authorizations may be provided using third party electronic authorization systems 904.

Third party electronic authorization systems 904 may receive information regarding locks and limits on a virtual card number. Third party electronic authorization systems 904 may also be in communication with a database that includes debit/credit card numbers, virtual numbers, locks and limits and further described herein, shipping (and/or billing and payment) addresses and history.

The locks and limits on any virtual card number may be provided by the center of online service 908. The eWallet may be a platform and/or conduit for communication between the consumer and the center of online service, 910. An online banking website 912 may also provide a platform for communication with a center of online service. The center of online service may communicate with other online applications via an online servicing channel, 914.

It should be noted that third party authorizations may be implemented as follows: first, a customer may receive a number for one-time use, or for single-merchant use, from a third party. The customer may then approach the merchant and request goods and/or services in return for the number. The merchant may then approach a financial institution that operates together with the third party. The third party may provide authorization information to the financial institution which may then communicate the information to the merchant. In an alternative embodiment of the process shown in FIG. 9A, the authorization and/or settlement may be provided by the financial institution supporting the eWallet application.

FIG. 9B shows an illustrative flow diagram of an authorization and settlement process according to the invention. FIG. 9B shows an authorization process that may preferably be provided by a third party or by the financial institution supporting the eWallet.

Step 920 shows a financial institution providing a static shopping number, and a dynamic number for use in conjunction with the static shopping number. Preferably, the financial institution (and/or the user) may set locks and/or limits with respect to use of the dynamic number.

Upon use of the dynamic number, systems and methods according to the invention may check authorization of the static shopping number and the dynamic shopping number, 922, using an authorization system 924. Authorization system 924 may preferably access a database 926. Database 926 may include static shopping number information, dynamic shopping number information, locks and limits associated with the dynamic number, shipping address information and/or shopping history information. It should be noted that the process shown in FIG. 9B may work in conjunction with the online banking 930 which is in contact with the center of online service 928 independent of the operation of the eWallet application.

FIG. 10 shows an exemplary screen shot according to the invention. The screen shot shows a Graphical User Interface that may be used to categorize purchase and/or other transactional receipts which can then be viewed and printed at any time.

Such receipts can be sorted by date 1002, retailer 1004, user 1006, primary card number 1008, one-time user number 1010, device number 1012, and/or amount 1014 or any other suitable field. Additionally, the information stored in the screen may preferably be exported into a suitable electronic spread sheet application such as Excel™.

Systems and methods according to the invention may also be open for use to all financial institution cards, including but not limited to: HELOC, Small Business, commercial prepaid cards, any form of mobile payments and/or payroll cards.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for providing an eWallet are set forth herein. Persons skilled in the art will appreciate that the present invention can be practiced by other than the described embodiments, which are presented for purposes of illustration rather than of limitation. The present invention is limited only by the claims that follow.

What is claimed is:

1. One or more computer-readable media storing computer-executable instructions which, when executed by a processor on a computer system, perform a method for enhancing online shopping, the method comprising:
displaying on a computer display a menu bar that includes an online shopping enhancement icon;
receiving a selection of the icon; and
in response to receiving a selection of the icon, displaying an online shopping enhancement dialogue box including a selectable option for displaying user bank account information.

2. The method of claim 1 further comprising displaying an online shopping enhancement dialogue box including a selectable option for transferring funds between two bank accounts.

3. The method of claim 1 further comprising using electronic information from a bank account to populate an online shopping profile

4. The method of claim 1 further comprising using electronic information from a bank account to populate an online merchant checkout dialogue box.

5. The method of claim 1 further comprising using electronic information from a bank account to update an online shopping profile.

6. The method of claim 1 further comprising displaying an online shopping enhancement dialogue box that accesses and displays account balances in real time.

7. The method of claim 1 further comprising displaying an online shopping enhancement dialogue box that accesses and displays special offers relating to a user product keyword search and/or user product purchase.

8. The method of claim 1 further comprising displaying an online shopping enhancement dialogue box that that displays an option to transfer funds between the financial institution accounts.

9. The method of claim 1 further comprising:
generating a static shopping number; and
generating a dynamic shopping number;
wherein the static shopping number and the dynamic shopping number may be used together to provide a limited shopping credit line.

10. One or more computer-readable media storing computer-executable instructions which, when executed by a processor on a computer system, perform a method for populating an online shopping profile, the method comprising:
retrieving customer data from the online banking data system; and
using the customer data to electronically populate an online shopping enhancement profile.

11. The method of claim 10 further comprising displaying an online shopping enhancement dialogue box including a selectable option for transferring funds between two financial institution accounts.

12. The method of claim 10 further comprising using the online shopping profile to populate an online merchant checkout dialogue box.

13. The method of claim 10 further comprising using electronic information from a financial institution account to update an online shopping profile.

14. The method of claim 10 further comprising displaying an online shopping enhancement dialogue box that accesses and displays account balances in real time.

15. The method of claim 10 further comprising displaying an option to transfer funds between the accounts.

16. The method of claim 10 further comprising displaying an online shopping enhancement dialogue box that accesses special offers relating to a user input keyword.

17. The method of claim 10 further comprising displaying an online shopping enhancement dialogue box that displays special offers relating to a user input keyword search.

18. The method of claim 10 further comprising displaying an online shopping enhancement dialogue box that displays special offers relating to a user product purchase.

19. The method of claim 10 further comprising:
generating a static shopping number; and
generating a dynamic shopping number;
wherein the static shopping number and the dynamic shopping number may be used together to provide a limited shopping credit line.

20. A system to provide online shopping enhancement, the system comprising:
an input module configured to receive electronic information from a financial institution account;
a processor configured to use the received electronic information to configure an online shopping enhancement profile; and
an output module configured to use the online shopping enhancement profile to populate a merchant checkout dialogue box.

21. The system of claim 20 wherein the processor is further configured to generate a static shopping number and to generate a dynamic shopping number, the static shopping number and the dynamic shopping number for use by the output module in providing a limited shopping credit line.
